(19) United States
(12) Patent Application Publication
(10) Pub. No.: US 2015/0312765 A1
(43) Pub. Date: Oct. 29, 2015

(54) PORTABLE TERMINAL AND LOCK STATE CONTROL METHOD

(71) Applicant: KYOCERA CORPORATION, Kyoto-shi, Kyoto (JP)

(72) Inventor: Toshiaki NADE, Yokohama-shi, Kanagawa (JP)

(73) Assignee: KYOCERA Corporation, Kyoto-shi, Kyoto (JP)

(21) Appl. No.: 14/443,356

(22) PCT Filed: Nov. 14, 2013
(86) PCT No.: PCT/JP2013/080746

§ 371 Date: May 15, 2015

(30) Foreign Application Priority Data
Nov. 15, 2012 (JP) 2012-250872

(51) Int. Cl. H04W 12/08; H04M 1/725

(52) U.S. Cl. CPC H04W 12/08; H04M 1/72577

(57) ABSTRACT

A mobile phone 10 comprises a display 14 and a touch panel 16, and a lock state of restricting performance of the predetermined processing based on a touch operation is set when the power supply of the display 14 is turned off. If the lock state is set at the time that an application is performed, a lock screen that makes a processing screen being displayed a background. At approximately the same time, a performance situation of the application being performed is stored, and the application is suspended. Then, a produced lock screen is displayed when the power supply of the display 14 is turned on. If the lock state is canceled by a cancellation operation, the application suspended is resumed.

### FIELD OF ART

The present invention relates to a portable terminal and a lock state control method, and more specifically, a portable terminal and a lock state control method, capable of setting a lock state.

### BACKGROUND ART

A plurality of private codes are registered into a mobile phone terminal that is an example of a background art. A user can change a mode after an input of a private code by the private code that is used in canceling a security lock.

### SUMMARY OF THE INVENTION

### Problem to be Solved by the Invention

In the above-mentioned mobile phone terminal, a screen is shifted to a private code input screen whenever opening or closing of the mobile phone terminal is performed. If the mobile phone terminal is closed in order to handle another matter during a time of operating the mobile phone terminal, and then, the mobile phone terminal is opened after the matter settled, the private code input screen is displayed. At this time, the user may forget a situation before the mobile phone terminal is closed. In such a case, after the user cancels a security lock, it becomes hard for the user to resume a former operation.

Therefore, it is a primary object of the present invention to provide a novel portable terminal and lock state control method.

It is another object of the present invention to provide a portable terminal and lock state control method, capable of improving operability for a user.

### Means for Solving the Problem

A first aspect of the present invention is a portable terminal that has a display module and a touch panel provided in the display module, and a lock state of restricting a performance of predetermined processing based on a touch operation can be set, comprising: a producing module operable to produce a lock screen based on an arbitrary screen; a display processing module operable to display the lock screen when a power supply of the display module is turned on in a state where the lock state is set; and a canceling module operable to cancel the lock state when a cancellation operation is performed in a state where the lock screen is displayed.

A second aspect of the present invention is a lock state control method in a portable terminal that has a display module and a touch panel provided in the display module, and a lock state of restricting a performance of predetermined processing based on a touch operation can be set, a processor of the portable terminal performing steps of: producing a lock screen based on an arbitrary screen; display-processing the lock screen when a power supply of the display module is turned on in a state where the lock state is set; and canceling the lock state when a cancellation operation is performed in a state where the lock screen is displayed.

### Advantage of the Invention

According to the present invention, operability for the user can be improved.

The above described objects and other objects, features, aspects and advantages of the invention will become more apparent from the following detailed description of the invention when taken in conjunction with the accompanying drawings.

### BRIEF DESCRIPTION OF THE DRAWINGS

FIG. 1 is an illustration view showing an appearance of a mobile phone of an embodiment of the present invention.

FIG. 2 is an illustration view showing electric structure of the mobile phone shown in FIG. 1.

FIG. 3 is an illustration view showing an example of a first home screen displayed on a display shown in FIG. 1.

FIG. 4 illustrates an example of an operation that changes a home screen displayed on the display shown in FIG. 1, wherein FIG. 4(A) shows an example of an operation to the first home screen, and FIG. 4(B) shows an example of a second home screen displayed by an operation of changing a home screen.

FIG. 5 illustrates an example of a touch operation that performs processing relevant to a function icon shown in FIG. 3, wherein FIG. 5(A) shows an example of a touch operation to the function icon, and FIG. 5(B) shows an example of a screen displayed by performed processing.

FIG. 6 is an illustration view showing an example of a lock screen displayed on the display shown in FIG. 1.

FIG. 7 illustrates an example of a cancellation operation performed to the lock screen shown in FIG. 6, wherein FIG. 7(A) shows an example of a touch operation to a lock object, FIG. 7(B) shows an example of a touch operation to a cancellation object, and FIG. 7(C) shows an example of a state where an application that is suspended is resumed.

FIG. 8 is an illustration view showing another example of the lock screen displayed on the display shown in FIG. 1.

FIG. 9 is an illustration view showing an example of a memory map of a RAM shown in FIG. 2.

FIG. 10 is a flowchart showing an example of lock screen producing processing of a processor shown in FIG. 2.

FIG. 11 is a flowchart showing an example of lock state canceling processing of the processor shown in FIG. 2.

FIG. 12 is an illustration view showing a further example of the lock screen displayed on the display shown in FIG. 1.

FIG. 13 illustrates an example of a cancellation operation performed to the lock screen shown in FIG. 12, wherein FIG. 13(A) shows an example of a touch operation to a lock object, FIG. 13(B) shows an example of a touch operation to a cancellation icon, and FIG. 13(C) shows an example of a state where an application relevant to the cancellation icon shown in FIG. 13(B) is performed.

FIG. 14 is a flowchart showing another example of the lock screen producing processing of a processor shown in FIG. 2.

FIG. 15 is a flowchart showing another example of the lock state canceling processing of the processor shown in FIG. 2.

FIG. 16 is an illustration view showing the other example of the lock screen displayed on the display shown in FIG. 1.

### FORMS FOR EMBODYING INVENTION

### First Embodiment

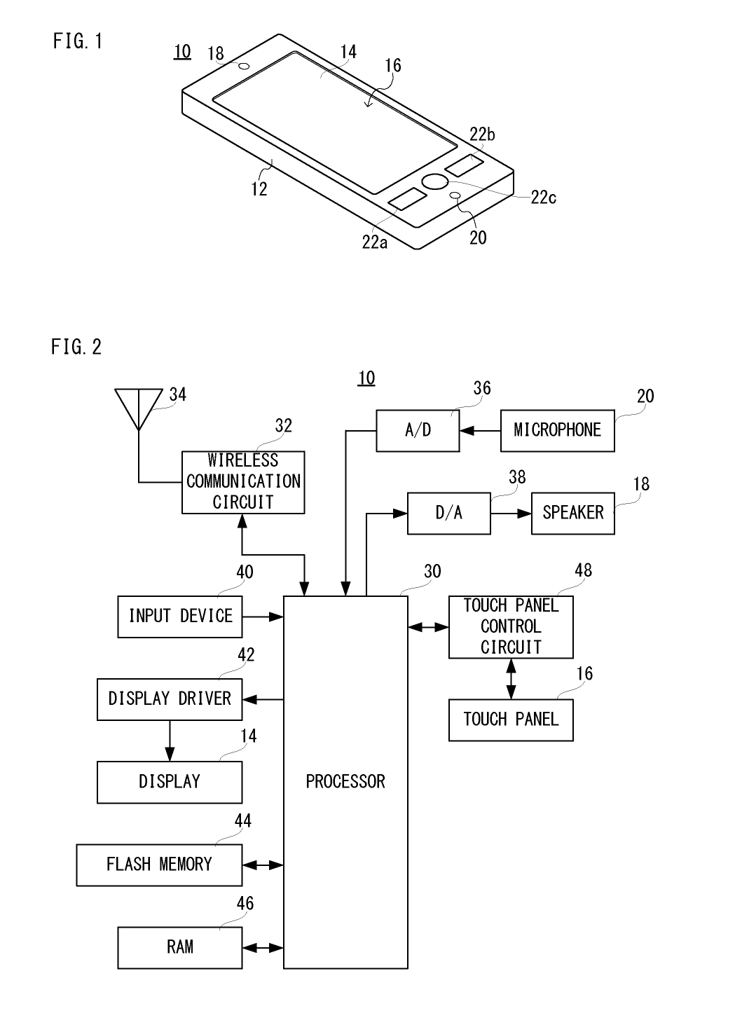

With referring to FIG. 1, a mobile phone 10 of an embodiment according to the present invention is a smartphone as an example, and includes a longitudinal flat rectangular housing 12. However, it is pointed out in advance that the present invention can be applied to an arbitrary portable terminal such as a tablet terminal, a PDA, etc.

A display 14 of a liquid crystal, organic EL or the like that functions as a display module is provided on a main surface (front surface) of the housing 12. A touch panel 16 is provided on the display 14. Therefore, in the mobile phone 10 of this embodiment, the most part of an input operation excepting an input by an operation of hardware keys described later is performed through the touch panel 16.

A speaker 18 is housed in the housing 12 at one end of a longitudinal direction on a side of the main surface, and a microphone 20 is housed at the other end in the longitudinal direction on the side of the main surface.

As hardware keys constituting an input operating module together with the touch panel 16, a call key 22a, an end key 22b and a home key 22c are provided on the main surface of the housing 12, in this embodiment.

The user can input a telephone number by performing a touch operation by the touch panel 16 to a dial key displayed on the display 14, for example, and start a telephone conversation by operating the call key 22a. If the end key 22b is operated, the telephone conversation can be ended. In addition, by long-depressing the end key 22b, it is possible to turn on/off a power supply of the mobile phone 10.

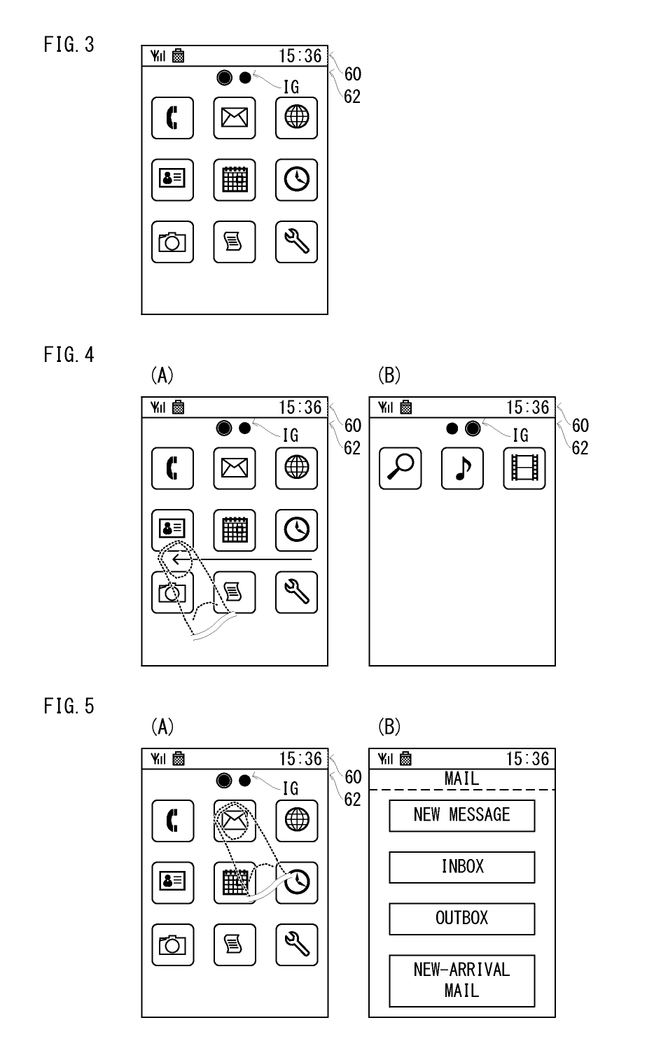

Furthermore, if the home key 22c is operated, a default home screen (see FIG. 3) is displayed on the display 14. The user can perform predetermined processing by performing a touch operation by the touch panel 16 to a function icon (first icon) being displayed on the display 14 in that state. In addition, processing of an application, processing to display a menu screen, etc. are included in the predetermined processing.

With referring to FIG. 2, the mobile phone 10 of the embodiment shown in FIG. 1 includes a processor 30 that is called as a computer or a CPU. The processor 30 is connected with a wireless communication circuit 32, an A/D converter 36, a D/A converter 38, an input device 40, a display driver 42, a flash memory 44, a RAM 46, a touch panel control circuit 48, etc.

The processor 30 is in charge of entire control of the mobile phone 10. A whole or a part of a program that is set in advance in the flash memory 44 is, in use, developed or loaded into the RAM 46 that functions as a storing module, and the processor 30 operates in accordance with the program on the RAM 46. In addition, the RAM 46 is further used as a working area or buffer area for the processor 30.

The input device 40 includes the touch panel 16 and the hardware keys 22 shown in FIG. 1. Therefore, an operation receiving module that receives a touch operation to the touch panel 16 by the user and a key operation to the hard key 22 by the user can be constituted. Information (key data) of the hardware key that the user operates is input to the processor 30.

The wireless communication circuit 32 is a circuit for sending and receiving a radio wave for a telephone conversation, a mail, etc. via an antenna 34. In this embodiment, the wireless communication circuit 32 is a circuit for performing a wireless communication with a CDMA system. For example, if the user designates an outgoing call (telephone call) using the input device 40, the wireless communication circuit 32 performs telephone call processing under instructions from the processor 30 and outputs a telephone call signal via the antenna 34. The telephone call signal is sent to a telephone at the other end of line through a base station and a communication network. Then, if incoming call processing is performed on the telephone at the other end of line, a communication-capable state is established and the processor 30 performs telephone conversation processing.

The microphone 20 shown in FIG. 1 is connected to the A/D converter 36, and a voice signal from the microphone 20 is input to the processor 30 as digital voice data through the A/D converter 36. The speaker 18 is connected to the D/A converter 38. The D/A converter 38 converts digital voice data into a voice signal to apply to the speaker 18 via an amplifier. Therefore, a voice based on the voice data is output from the speaker 18.

The display driver 42 is connected to the display 14, and therefore, the display 14 displays an image or video in accordance with image or video data that is output from the processor 30. That is, the display driver 42 controls display of the display 14 that is connected to the display driver 40 under instructions by the processor 30. In addition, the display driver 42 includes a video memory that temporarily stores the image or video data to be displayed. The display 14 is provided with a backlight that includes a light source of an LED or the like, for example, and the display driver 42 controls, according to the instructions from the processor 30, brightness, lighting/extinction of the backlight.

The touch panel 16 shown in FIG. 1 is connected to a touch panel control circuit 48. The touch panel control circuit 48 applies to the touch panel 16 a necessary voltage or the like and inputs to the processor 30 a touch start signal indicating a start of a touch to the touch panel 16 by the user, a touch end signal indicating an end of a touch by the user, and coordinate data indicating a touch position that the user touches. Therefore, the processor 30 can determine which object displayed on the display 14 is touched by the user based on the coordinate data.

In the embodiment, the touch panel 16 is of an electrostatic capacitance system that detects change of an electrostatic capacitance occurs between a surface and an object such as a finger close to the surface. The touch panel 16 detects that one or more fingers are brought into contact with the touch panel 16, for example. Therefore, the touch panel 16 is called a pointing device. The touch panel control circuit 48 functions as a detecting module, and detects a touch operation within a touch-effective range of the touch panel 16, and outputs to the processor 30 coordinate data indicative of a position of the touch operation. That is, the user inputs to the mobile phone 10 an operation position, an operation direction, etc. through a touch operation on the surface of the touch panel 16.

A tap operation, a long tap operation, a flick operation, a slide operation, etc. are included in the touch operation of this embodiment.

The tap operation is an operation that a finger is brought into contact with the surface of the touch panel 16, and then, the finger is lifted (released) from the surface of the touch panel 16 within a short time. The long tap operation is an operation that a finger is continued to be brought into contact with a surface of the touch panel 16 for a predetermined time period, and then, the finger is released from the surface of the touch panel 16. The flick operation is an operation that a finger is brought into contact with the surface of the touch panel 16, and flips the finger in an arbitrary direction with a predetermined speed or more. The slide operation is an operation that a finger is moved in an arbitrary direction while being kept to be brought into contact with the surface of the touch panel 16, and then, the finger is released from the surface of the touch panel 16.

In addition, in the above-mentioned slide operation, a slide operation that a finger is brought into contact with an object being displayed on the surface of the display 14 and makes the object move, that is, a so-called drag operation is also included.

In addition, in the following description, an operation that a finger is released from a surface of the touch panel 16 after the drag operation is called a drop operation. Furthermore, there is an occasion that the touch operation, the long tap operation, the flick operation, the slide operation, the drag operation and the drop operation may be described with omitting the word “operation”, respectively.

In addition, for a detection system of the touch panel 16, instead the above-mentioned an electrostatic capacitance system, a resistance film system, an ultrasonic system, an infrared ray system, an electromagnetic induction system or the like may be adopted. Furthermore, a touch operation is not limited to a finger, may be performed by a stylus or the like.

Furthermore, a picto indicating a state of the mobile phone 10, an icon for performing a function, a widget (gadget) indicating a part or whole of information acquired by an application that is performed in the background or simply performed, a file, a folder, etc. are included in the object of this embodiment.

In the mobile phone 10 of this embodiment, the user can perform an application such as a mail function, an alarm function, etc. other than a telephone function.

FIG. 3 is an illustration view showing an example of a home screen displayed on the display 14. A display range of the display 14 includes a status display area 60 and a function display area 62. In the status display area 60, a picto showing a radio-wave receiving situation by the antenna 34, a picto showing a residual battery capacity of a secondary battery and a date and time are displayed. Furthermore, a home screen including a plurality of function icons is displayed in the function display area 62.

Furthermore, a plurality of home screens are set to the mobile phone 10 of this embodiment, and an indicator IG indicating a home screen currently displayed is displayed in an upper portion of the home screen. For example, since two figures are included in the indicator IG shown in FIG. 3, it is possible to understand that two home screens are set. Furthermore, since a figure in a left side is selected by a cursor, FIG. 3 shows that a home screen in a left side among the two home screens is currently displayed. In addition, in the following description, the home screen of the left side shown in FIG. 3 is called a first home screen.

With reference to FIGS. 4(A) and 4(B), if a touch operation that is slid leftward is performed in a state where the first home screen is displayed, a home screen in a right side (second home screen) is displayed on the display 14. Function icons different from those of the first home screen are displayed on the second home screen, and the indicator IG is rendered in a state where a figure of a right side is selected by the cursor. Furthermore, although illustration is omitted, if a touch operation that is slid rightward is performed in a state where the second home screen is displayed, the first home screen is displayed again. Hereinafter, an operation that changes the display of the display 14 as mentioned above is called a screen change operation.

Furthermore, if a touch operation more than a predetermined time period is performed to an arbitrary function icon, it is rendered in a state where the user can change a display position of the function icon arbitrarily by a touch operation. Furthermore, the user can change the number of home screens arbitrarily. Furthermore, the user can also move arbitrarily the function icon currently displayed on the home screen to a home screen newly added.

In addition, in this embodiment, a home screen set in the left side most, i.e., the first home screen is made a default home screen that is to be displayed at a time that the home key 22c is operated.

FIGS. 5(A) and 5(B) illustrate an example of an operation for performing an application from the home screen. For example, a mail application becomes to be performed if the user performs a touch operation to the function icon relevant to the mail application as shown in FIG. 5(A). When the mail application is performed, a GUI of the mail application is displayed in the function display area 62, as shown in FIG. 5(B). Then, the user can perform confirmation of a new-arrival mail, creation of a new message, etc. by performing a touch operation to an arbitrary software key in the function display area 62.

Here, in the mobile phone 10 of this embodiment, in order to prevent an erroneous operation due to an unintentional input by the user to the touch panel 16, it is possible to set a lock state restricting performance of the predetermined processing based on a touch operation. If the end key 22b is operated, for example, the power supply of the display 14 and the touch panel 16 is turned off and a lock state is set. If the home key 22c, etc. is operated in this state, the power supply of the display 14 and the touch panel 16 is turned on, and the lock screen is displayed, and a cancellation operation of a lock state becomes to be received.

Then, in this embodiment, if the power supply of the display 14 is turned off in a state where an arbitrary screen is displayed by the application etc., and if a lock state is set, a lock screen is produced based on the arbitrary screen. In this state, if the user turns on the power supply of the display 14, a produced lock screen is displayed. Therefore, before canceling a lock state, the user can easily remember a situation before the lock state is set. Therefore, the operability for the user after the lock state is canceled is improved.

In the following, a flow after a lock state is set until the lock state is canceled will be described specifically. If the power supply of the display 14 is turned off in a state where a processing screen of the mail application is displayed, for example, a lock screen that makes this processing screen a background is produced. Furthermore, the lock screen is produced, and a performance situation of the mail application is stored, while the mail application is suspended. Furthermore, a lock state is set at approximately the same time of these processing.

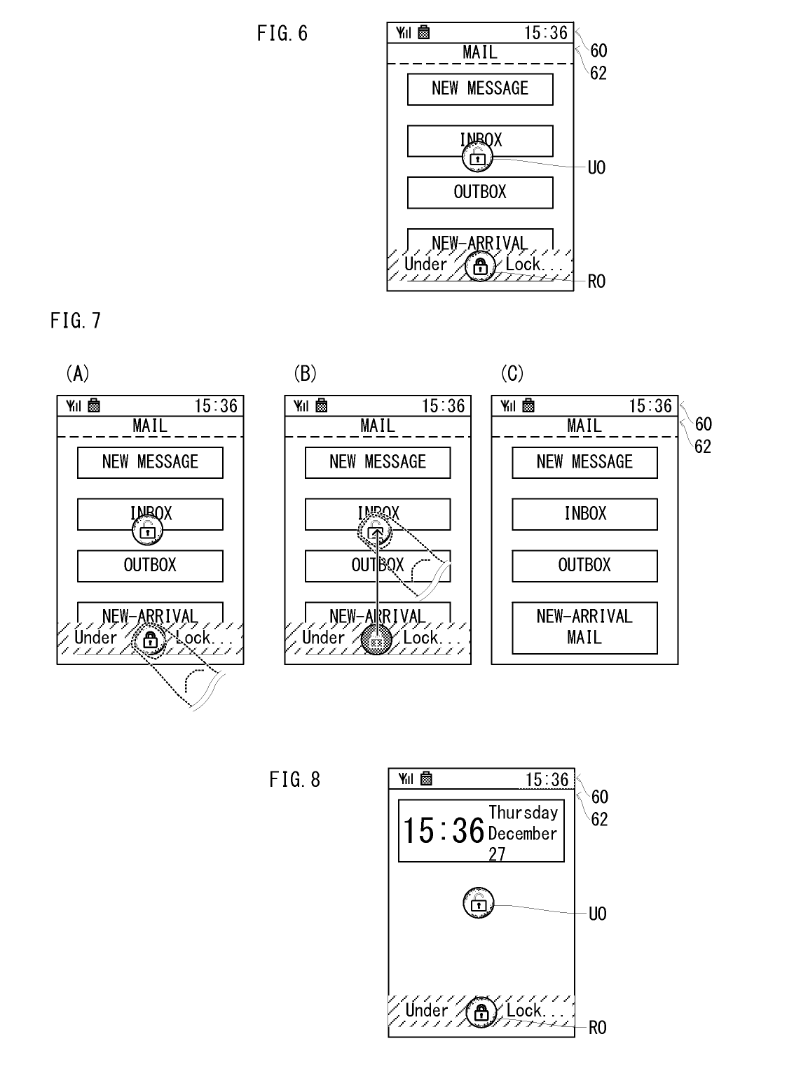

With reference to FIG. 6, if the power supply of the display 14 is turned on in the lock state, a lock screen that makes the processing screen of the mail application a background is displayed on the display 14. In a lower portion of the lock screen, an indication indicative of the lock screen and a lock object RO are displayed. Furthermore, a cancellation object UO for canceling the lock state is displayed in approximately the center of the lock screen. In addition, since a GUI of the mail application currently displayed in the lock screen is the background, the predetermined processing is not performed even if a touch operation is performed to this GUI.

With reference to FIGS. 7(A)-7(C), a cancellation operation for canceling the lock state will be described. If the finger is slid toward the cancellation object UO after the lock object RO is touched by the finger, in order to indicate that the lock object RO receives a cancellation operation, a color of the lock object RO is reversed. If the finger is slid to the display position of the cancellation object UO in this state and then released, the lock state is canceled. Furthermore, since the mail application is resumed based on the performance situation of the mail application being stored, a screen at the time that the mail application is suspended, i. e., a processing screen that is approximately the same as the processing screen shown in FIG. 5 is displayed on the display 14. In addition, although a locus of the slide is illustrated in the drawing, the locus of the slide is not displayed in fact.

Thus, since the processing screen just before the application is suspended is displayed in the lock screen even if the lock state is set at the time that the application is performed, after canceling the lock state, it becomes easy for the user to resume the operation to the application. Especially, since the processing screen just before the application is suspended is displayed as the background of the lock screen, it becomes easy for the user to grasp a situation that the lock state is set.

Here, since the processing screen is not displayed if the lock state is set at the time that the application is not performed, a lock screen is not produced. If the display 14 is turned on in this state, a normal lock screen that is set in advance (hereinafter, called a normal lock screen) is displayed.

With reference to FIG. 8, in the normal lock screen, a date and time is displayed in an upper portion, the cancellation object UO is displayed in approximately the center, and the indication indicative of the lock screen and the lock object RO are displayed in a lower portion. Then, the lock state is canceled if an operation similar to the cancellation operation shown in FIGS. 7(A) and 7(B) is performed. Furthermore, if the lock state is canceled, the first home screen is displayed on the display 14.

Thus, if the lock state is set when the application is not performed, the normal lock screen can be displayed.

In addition, in this embodiment, in order to indicate that the cancellation operation is received, a color of the lock object RO is reversed, but a user may be notified by vibration by a vibrator, sound, etc. in other embodiments.

In addition, even if no operation to the mobile phone 10 exists for a predetermined time period, the display 14 is turned off automatically and a lock state is set.

Furthermore, in the lock state of this embodiment, since the power supply of the display 14 and the touch panel 16 is turned off until the lock screen becomes to be displayed, the power consumption of the mobile phone 10 is suppressed. However, in other embodiments, a touch operation may be made invalid by making the processor 30 not process a touch operation being input without turning off the power supply of the touch panel 16.

Furthermore, in other embodiments, the lock state may be canceled to display the home screen when the lock object RO is flicked in an arbitrary direction. Furthermore, in a case where the display 14 of the mobile phone 10 includes a pressure-sensitive sensor and feedback processing of the touch operation according to a vibrator is performed, if a cancellation icon UO is operated by a touch operation depressing the touch panel 16 (hereinafter, click operation), a lock state may be canceled.

Furthermore, an image displayed on the display 14 of this embodiment is displayed using a plurality of layers. Therefore, the lock object RO and the cancellation object UO, and the background image produced based on the arbitrary screen are drawn using different layers. However, the lock object RO, the cancellation object UO and the background image may be drawn in the same layer.

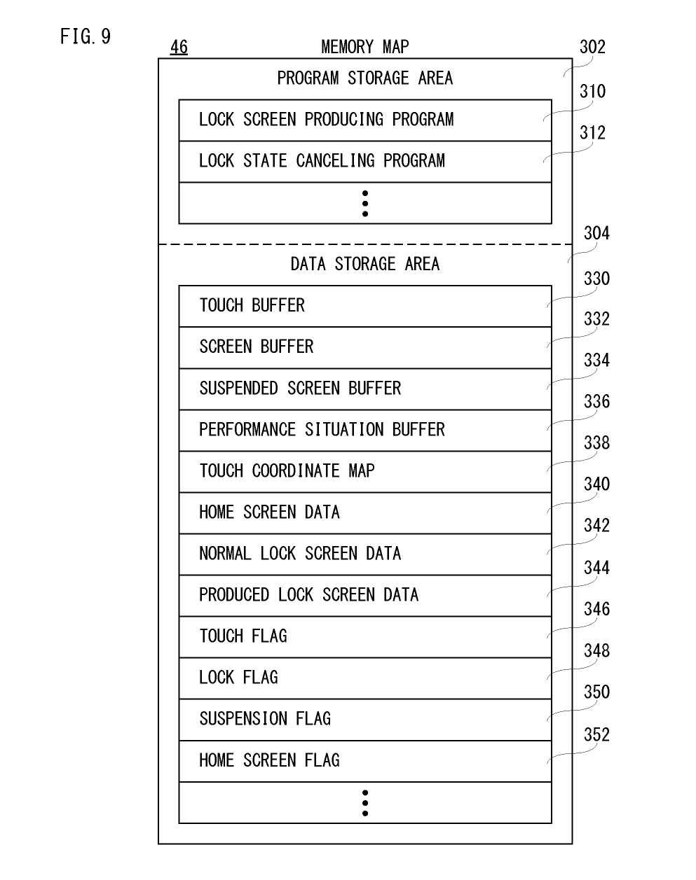

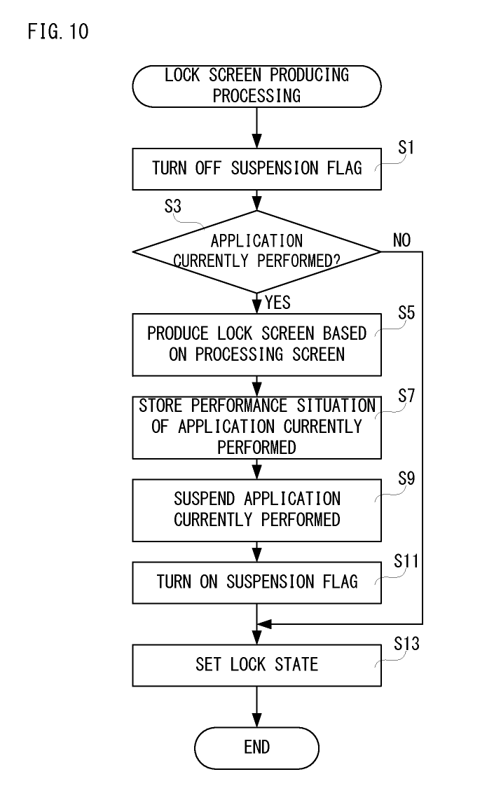

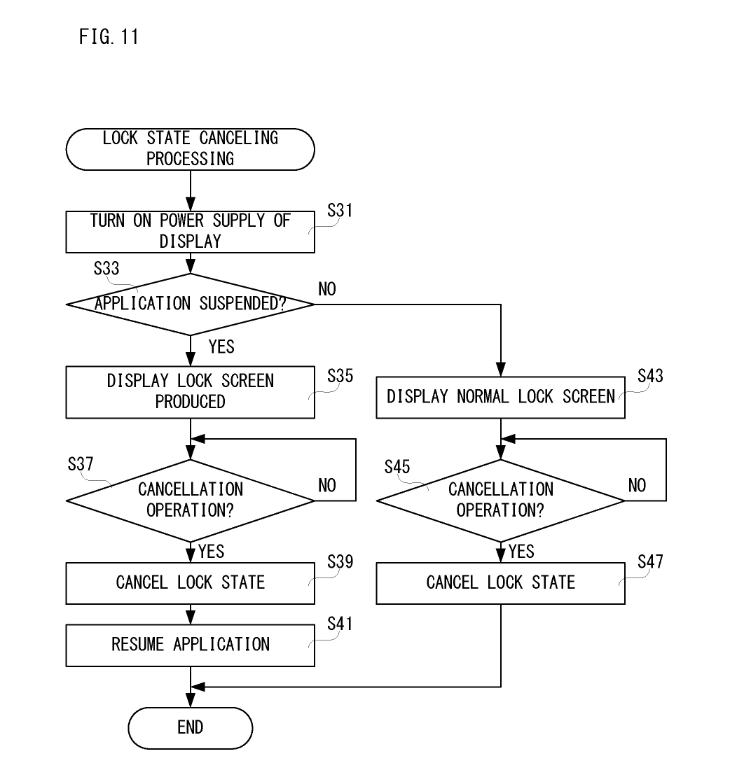

In the above, the feature of the embodiment is outlined. In the following, the embodiment will be described in detail using a memory map showing in FIG. 9 and flowcharts shown in FIG. 10 and FIG. 11.

With referring FIG. 9, the RAM 46 shown in FIG. 2 is formed with a program storage area 302 and a data storage area 304. As previously described, the program storage area 302 is an area for reading and storing (developing) a whole or a part of program data that is set in advance in the flash memory 44 (FIG. 2).

The program storage area 302 is stored with a lock screen producing program 310, a lock state canceling program 312, etc. The lock screen producing program 310 is a program for producing a lock screen. The lock state canceling program 312 is a program for canceling a lock state or for performing a function while canceling a lock state. Furthermore, the lock screen producing program 310 and the lock state canceling program 312 may be called a lock state control program collectively.

In addition, the program storage area 302 further includes programs for performing a mail application, an alarm application, etc.

The data storage area 304 of the RAM 46 is formed with a touch buffer 330, a screen buffer 332, a suspension screen buffer 334, and a performance situation buffer 336. Furthermore, the data storage area 304 is stored with a touch coordinate map 338, home screen data 340, normal lock screen data 342, produced lock screen data 344, etc., and provided with a touch flag 346, a lock flag 348, a suspension flag 350, a home screen flag 352, etc.

The touch buffer 330 is stored with touch coordinate data that is output by the touch panel control circuit 48. In the screen buffer 332, data of the home screen, the processing screen or the like to be displayed on the display 14 is stored. The processing screen of the application that is suspended is stored in the suspension screen buffer 334. When the application is suspended, a performance situation of the application is stored in the performance situation buffer 336.

The touch coordinate map 338 is data for mapping the touch coordinate in the touch operation with the display coordinate of the display 14. That is, based on the touch coordinate map 338, a result of the touch operation performed to the touch panel 16 is reflected in the display of the display 14.

The home screen data 340 is data for displaying the home screen being set, for example, the first home screen and the second home screen. The normal lock screen data 342 is data of the normal lock screen shown in FIG. 8. The produced lock screen data 344 is data of the lock screen produced by the processing of the lock screen producing program 310.

The touch flag 346 is a flag for determining whether a touch to the touch panel 16 is performed. The touch flag 346 is constructed by a 1-bit register, for example. If the touch flag 346 is turned on (true), a data value “1” is set in the register. On the other hand, if the touch flag 346 is turned-off (false), a data value “0” is set in the register. In addition, the touch flag 346 is switched on/off based on a signal that is output by the touch panel control circuit 48.

Furthermore, the lock flag 348 is a flag indicating whether the lock state is set. For example, the lock flag 348 is turned on in response to the processing that turns off the power supply of the display 14 and the touch panel 16. Furthermore, the lock flag 348 is switched on or off according to the processing of the above-mentioned lock state canceling program.

The suspension flag 350 is a flag indicating whether the application is suspended. The home screen flag 352 is a flag indicating whether the lock state is set when the home screen is displayed.

In addition, since structure of each of the lock flag 348, the suspension flag 350 and the home screen flag 352 is approximately the same as those of the touch flag 346, a detailed description about the structure is omitted.

The data storage area 304 is stored with the image data that is displayed in the standby state, data of character strings, etc., and provided with counters and flags necessary for an operation of the mobile phone 10.

The processor 30 processes a plurality of tasks including lock screen producing processing shown in FIG. 10, lock state canceling processing shown in FIG. 11, etc. in parallel with each other under controls of Linux (registered trademark)-base OS such as Android (registered trademark) and REX, or other OSs.

The lock screen producing processing is started when the power supply of the display 14 is turned off The processor 30 turns off the suspension flag 350 in a step S1. That is, the suspension flag 350 is initialized. Subsequently, the processor 30 determines, in a step S3, whether the application is being performed. If “NO” is determined in the step S3, that is, if the application is not performed, the processor 30 sets a lock state in a step S13, and terminates the lock screen producing processing. That is, the lock flag 348 is turned on.

On the other hand, if “YES” is determined in the step S3, that is, if the mail application is being performed, for example, the processor 30 produces a lock screen based on a processing screen in a step S5. That is, a lock screen is produced based on the data of the processing screen stored in the screen buffer 332. In addition, data of a lock screen that is produced is saved in the RAM 46 as the produced lock screen data 344. In addition, the processor 30 that performs the processing of the step S5 functions as a producing module.

Subsequently, the processor 30 stores, in a step S7, a performance situation of the application currently performed. When the mail application is performed, for example, information of the software key etc. being selected, etc. is stored in the performance situation buffer 336. In addition, the processor 30 that performs the processing of the step S7 functions as a storing processing module.

Subsequently, the processor 30 suspends the application currently performed in a step S9. The processor 30 suspends (ends) the mail application if the mail application is being performed, for example. Furthermore, the processing screen at this time is stored in the suspension screen buffer 334.

Subsequently, the processor 30 turns on the suspension flag 350 in a step S11. That is, in order to indicate that the application is suspended, the suspension flag 350 is turned on. Subsequently, the processor 30 sets a lock state in a step S13. Then, if the processing of the step S13 is ended, the processor 30 terminates the lock screen producing processing.

FIG. 11 is a flowchart of lock state canceling processing. If an operation that turns on the power supply of the display 14 is performed, for example, the processor 30 turns on the power supply of the display 14 in a step S31. Subsequently, the processor 30 determines, in a step S33, whether that the application is suspended. That is, it is determined whether the suspension flag 350 is turned on. If “YES” is determined in the step S33, that is, if the application is suspended, the processor 30 displays the produced lock screen in a step S35. That is, the processor 30 displays a lock screen as shown in FIG. 6, for example on the display 14 based on the produced lock screen data 344. In addition, the processor 30 that performs the processing of the step S35 functions as a display processing module.

The processor 30 determines, in a step S37, whether a cancellation operation is performed. The processor 30 determines whether a cancellation operation is performed, as shown in FIGS. 7(A) and 7(B), for example. If “NO” is determined in the step S37, that is, if a cancellation operation is not performed, the processor 30 repeats the processing of the step S37. On the other hand, if “YES” is determined in the step S37, that is, if a cancellation operation is performed, the processor 30 cancels the lock state in a step S39. That is, the lock flag 348 is turned off. In addition, the processor 30 that performs the processing of the step S39 functions as a canceling module.

Subsequently, the processor 30 resumes the application in a step S41. That is, the processor 30 displays the processing screen stored in the suspension screen buffer 334 on the display 14, and resumes (performs) the application based on the content stored in the performance situation buffer 336. Then, if the processing of the step S41 is ended, the processor 30 terminates the lock state canceling processing. In addition, the processor 30 that performs the processing of the step S41 functions as a resumption module.

Here, if “NO” is determined in the step S33, that is, if the application is not suspended, the processor 30 displays a normal lock screen in a step S43. That is, the processor 30 displays the lock screen as shown in FIG. 8 on the display 14 based on the normal lock screen data 342. In addition, the processor 30 that performs the processing of the step S43 functions as a normal lock screen display processing module.

Subsequently, the processor 30 determines, in a step S45, whether a cancellation operation is performed. If “NO” is determined in the step S45, that is, if a cancellation operation is not performed, the processor 30 repeats the processing of the step S45. On the other hand, if “YES” is determined in the step S45, that is, if a cancellation operation is performed, the processor 30 cancels the lock state in a step S47. That is, the lock flag 348 is turned off Then, if the processing of the step S47 is ended, the processor 30 terminates the lock state canceling processing.

### Second Embodiment

In the second embodiment, when a lock state is set in a state where a home screen is displayed, a lock screen is produced based on the home screen. Then, in the lock screen thus produced, a user can perform arbitrary processing while canceling the lock state.

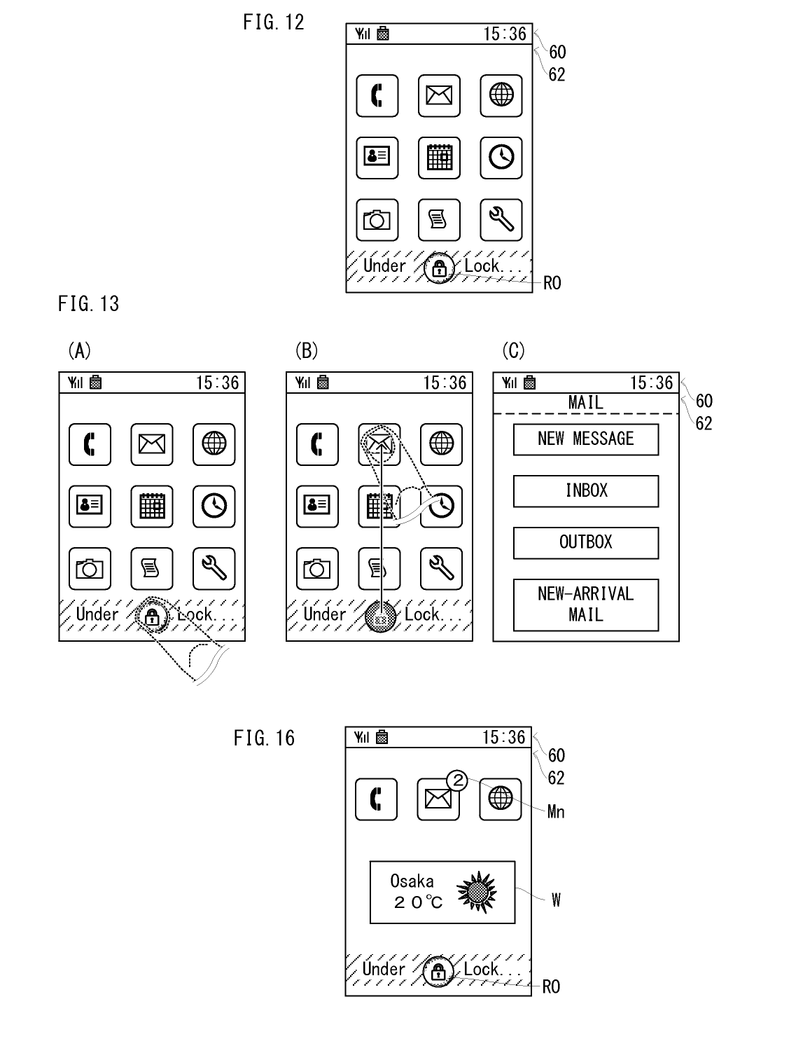

FIG. 12 is an illustration view showing the lock screen produced based on the first home screen. A cancellation icon corresponding to a function icon included in the first home screen is displayed in the lock screen. Since the cancellation icon is displayed using the same image data as the corresponding function icon, an appearance thereof is approximately the same as the function icon. However, even if a touch operation is performed to the cancellation icon, the application is not performed.

Furthermore, in a lower portion of the lock screen, an indication indicative of the lock screen and a lock object RO are displayed. In addition, an indicator IG and the cancellation object UO are not displayed in the lock screen that is produced based on the home screen. By such a manner, the user can recognize that the mobile phone 10 is in the lock state.

With reference to FIGS. 13(A)-13(C), a cancellation operation for canceling the lock state will be described. If the finger is slid toward the cancellation icon corresponding to the arbitrary application after the lock object RO is touched by the finger, in order to indicate that the lock object RO receives a cancellation operation, a color of the lock object RO is reversed. If the finger is slid to the display position of the cancellation object corresponding to the mail application in this state and then released, the lock state is canceled and the mail application is performed. In addition, although a locus of the slide is illustrated in the drawing, the locus of the slide is not displayed in fact.

By displaying the lock screen thus produced based on the home screen, with feeling in operating the home screen, the user can perform an arbitrary application while canceling the lock state. More specifically, by operating the cancellation icon on the lock screen arranged similarly to the icon displayed on the home screen, for example, the user becomes to be able to perform an arbitrary application while canceling the lock state. Therefore, the operability for the user in the lock screen can be improved.

Here, although the lock screen based on the first home screen is described, if a lock state is set in a state where the second home screen is displayed, a lock screen is produced based on the second home screen.

In addition, in other embodiments, it may be possible to arbitrarily designate a home screen for producing a lock screen.

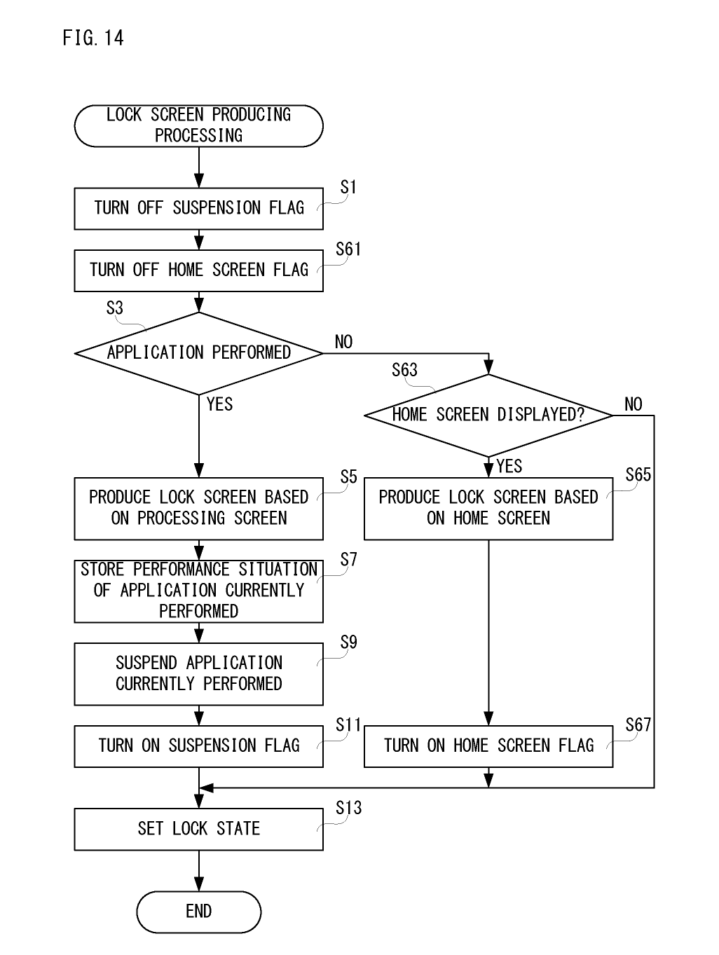

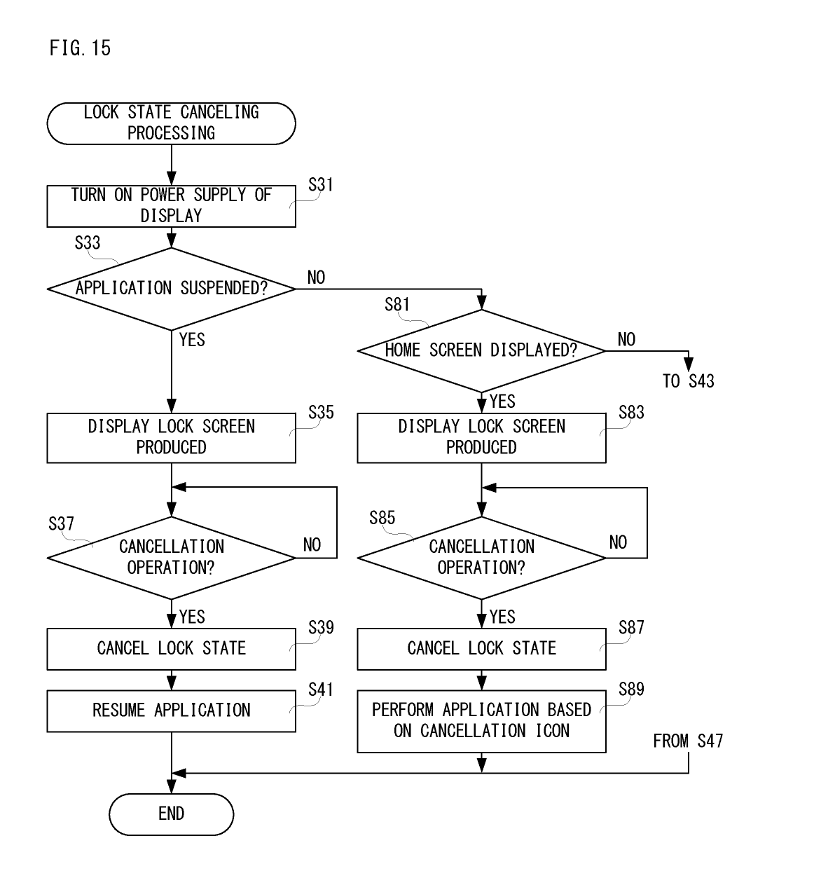

Although in the above, the feature of the second embodiment is outlined, in the following, the embodiment will be described in detail using flowcharts shown in FIG. 14 and FIG. 15.

FIG. 14 is a flowchart of lock screen producing processing of the second embodiment. In addition, since the processing of the steps S1-S13 in the lock screen producing processing of the second embodiment are the same as those of the first embodiment, a detailed description is omitted.

The lock screen producing processing is started when the power supply of the display 14 is turned off. The processor 30 turns off the suspension flag 350 in a step S1. Subsequently, the processor 30 turns off the home screen flag 352 in a step S61. That is, the home screen flag 352 is initialized.

Subsequently, the processor 30 determines, in the step S3, whether the application is being performed. If “YES” is determined in the step S3, that is, if the application is being performed, the processor 30 performs the processing of the steps S5-S13, and terminates the lock screen producing processing.

On the other hand, if “NO” is determined in the step S3, that is, if the application is not performed, the processor 30 determines, in a step S63, whether the home screen is displayed. That is, the processor 30 determines whether the data displaying the home screen is stored in the screen buffer 332. If “NO” is determined in the step S63, that is, if the home screen is not displayed, the processor 30 proceeds to the processing of the step S13.

On the other hand, if “YES” is determined in the step S63, that is, if the home screen is displayed, the processor 30 produces a lock screen based on the home screen in a step S65. For example, the processor 30 reads the data of the home screen currently displayed from the screen buffer 332, and produces a lock screen as shown in FIG. 12. In addition, the processor 30 that performs the processing of the step S65 functions as a producing module.

Subsequently, the processor 30 turns on the home screen flag 352 in a step S67. That is, in order to indicate that the lock state is set at the time that the home screen is displayed, the home screen flag 352 is turned on. Subsequently, the processor 30 sets the lock state in the step S13, and terminate the lock screen producing processing.

FIG. 15 is a flowchart of lock state canceling processing of the second embodiment. In addition, since the processing of the steps S31-S47 in the lock state canceling processing of the second embodiment are the same as those of the first embodiment, a detailed description is omitted.

If an operation that turns on the display 14 is performed, for example, the processor 30 turns on the power supply of the display 14 in the step S31. Subsequently, the processor 30 determines, in the step S33, whether the application is suspended. If “YES” is determined in the step S33, that is, if the application is suspended, the processor 30 performs the processing of the steps S35-S41, and terminates the lock state canceling processing.

On the other hand, if “NO” is determined in the step S33, that is, if the application is not suspended, the processor 30 determines, in a step S81, whether the home screen is displayed. That is, it is determined whether the home screen flag 352 is turned on. If “NO” is determined in the step S81, that is, if the home screen is not displayed before the lock state is set, the processor 30 performs the processing of the steps S43-S47, and terminates the lock state cancellation processing.

Furthermore, if “YES” is determined in the step S81, that is, if the home screen is displayed before the lock state is set, the processor 30 displays the produced lock screen in a step S83. That is, the processor 30 reads the produced lock screen data 344 corresponding to the lock screen that is produced based on the home screen, and displays the lock screen as shown in FIG. 12 on the display 14 based on that data. In addition, the processor 30 that performs the processing of the step S83 functions as a display processing module.

Subsequently, the processor 30 determines, in a step S85, whether it is a cancellation operation. The processor 30 determines whether a cancellation operation is performed, as shown in FIGS. 13(A) and 13(B), for example. If “NO” is determined in the step S85, that is, if a cancellation operation is not performed, the processor 30 repeats the processing of the step S85.

On the other hand, if “YES” is determined in the step S85, that is, if a cancellation operation is performed, the processor 30 cancels the lock state in a step S87. That is, the lock flag 348 is turned off. In addition, the processor 30 that performs the processing of the step S87 functions as a canceling module.

Subsequently, the processor 30 performs the application based on the cancellation icon in a step S89. As shown in FIG. 13(B), for example, when the cancellation operation is performed using the cancellation icon corresponding to the mail application, the processor 30 performs the mail application. Then, if the processing of the step S89 is ended, the processor 30 terminates the lock state cancellation processing. In addition, the processor 30 that performs the processing of the step S89 functions as a performance module.

Furthermore, in other examples of the second embodiment, in the home screen, a notification icon Mn indicating the number of matters such as new-arrival mails may be applied to the upper right of the function icon, and the information widget W including information of a weather report etc., may be displayed. Then, if a lock state is set when the notification icon Mn and/or the information widget W, etc. is displayed in the home screen, the lock screen that includes the notification icon Mn and/or the information widget W as shown in FIG. 16 is produced. Then, when displaying, after the content of the notification icon Mn and/or the information widget W is updated by the newest state, the home screen thus produced is displayed on the display 14.

Specifically describing, if “YES” is determined by the processing of the step S81 of the lock state canceling processing, before performing the processing of the step S83, the processor 30 acquires the newest content of the notification icon Mn and/or the information widget W from a server etc. Next, in the produced home screen, the processor 30 updates the content of the notification icon Mn and/or the information widget W of the lock screen based on the acquired newest content. Then, the processor 30 displays the updated lock screen in the step S83.

In addition, it is possible to arbitrarily combine the first embodiment and the second embodiment with each other, and since it is easy to conceive such combination, a detailed description thereof is omitted here.

In addition, although an arbitrary screen is made into the background of the lock screen in this embodiment, in other embodiments, an icon including a thumbnail image of an arbitrary screen may be made to be displayed on a lock screen, and a thumbnail image of an arbitrary screen may be made to be displayed into the cancellation object UO.

Furthermore, in other embodiments, when a cancellation operation of the lock state is performed, a security screen asking for an input of a password may be displayed. If a cancellation operation shown in FIGS. 7(A) and 7(B), for example is performed, a security screen is displayed on the display 14. Then, if a correct password is input in the security screen, a screen shown in FIG. 7(C) is displayed on the display 14. A re-input of a password is called for when an incorrect password is entered at this time.

Furthermore, if a telephone call occurs when the lock screen is displayed, the display of the lock screen is non-displayed, and a telephone call answer screen is displayed. In this telephone call answer screen, a telephone call answering object for canceling the lock state and for answering to the telephone call is included. Then, a telephone conversation is started if a touch operation is performed to the telephone call answering object.

Furthermore, in other embodiments, in a case where the display 14 is turned on when the lock state is set, a predetermined lock screen (for example, FIG. 8) is always displayed, and if the lock object RO is touched, the lock screen may be changed to the lock screen that makes the processing screen just before the application is suspended a background. By this, it is possible to prevent the content of the application having been performed from being seen by others against an intention of the user when the power supply of the display 14 is turned on.

Furthermore, in other embodiments, by adopting a display 14 having a touch panel function, the touch panel 16 on the display 14 may not be provided.

Furthermore, the programs used in this embodiment may be stored in an HDD of a data distribution server, and distributed to the mobile phone 10 via a network. The plurality of programs may be stored in storage medium such as an optical disk of CD, DVD, BD or the like, a USB memory, a memory card, etc., and then, such the storage medium may be sold or distributed. In a case where the programs downloaded via the above-described server or storage medium are installed to a portable terminal having the structure equal to the structure of the embodiment, it is possible to obtain advantages equal to advantages according to the embodiment.

The specific numerical values mentioned in this specification are only examples, and changeable properly in accordance with the change of product specifications.

It should be noted that reference numerals inside the parentheses and the supplements show one example of a corresponding relationship with the embodiments described above for easy understanding of the invention, and do not limit the invention.

An embodiment is a portable terminal that has a display module and a touch panel provided in the display module, and a lock state of restricting a performance of predetermined processing based on a touch operation can be set, comprising: a producing module operable to produce a lock screen based on an arbitrary screen; a display processing module operable to display the lock screen when a power supply of the display module is turned on in a state where the lock state is set; and a canceling module operable to cancel the lock state when a cancellation operation is performed in a state where the lock screen is displayed.

In the embodiment, the portable terminal (10: reference numeral exemplifying a portion or module corresponding in the embodiment, and so forth) has the display module (14) that is provided with the touch panel (16). If the power supply of the display module is turned off, for example, the lock state of restricting the performance of the predetermined processing based on a touch operation is set. The producing module (30, S5, S65) produces a lock screen based on an arbitrary screen currently displayed, for example. If the power supply of the display module is turned on in a state where the lock state is set, the display processing module (30, S35, S83) displays a produced lock screen. The canceling module (30, S39, S87) cancels the lock state if a cancellation operation is performed when the lock screen is displayed.

According to the embodiment, the user can easily remember, before canceling the lock state, a situation before the lock state is set. Therefore, the operability for the user after the lock state is canceled is improved.

In a further embodiment, the arbitrary screen is displayed when the predetermined processing is being performed, and the portable terminal further comprises a storing processing module operable to store a performance situation of the processing being performed when the lock state is set; and a resumption module operable to resume the predetermined processing based on the performance situation stored by the storing processing module when the cancellation operation is performed in a state where the lock screen is displayed.

In the further embodiment, if the predetermined processing is performed, the arbitrary screen (processing screen) is displayed on the display module. Therefore, if the lock state is set when the predetermined processing is performed, the lock screen is produced based on the arbitrary screen currently displayed by the predetermined processing. The storing processing module (30, S7) stores the performance situation of the processing, e.g., selection information on the software keys, etc., if the predetermined processing is performed when the lock state is set. The resumption module (30, S41) resumes the predetermined processing based on the performance situation stored if a cancellation operation is performed when the produced lock screen is displayed.

According to the further embodiment, since a screen just before the predetermined processing is suspended is displayed in the lock screen even if the lock state is set at the time that the predetermined processing is performed, it becomes easy for the user to resume the operation to the predetermined processing after canceling the lock state.

A still further embodiment further comprises a storing module operable to store a normal lock screen; and a normal lock screen display processing module operable to display the normal lock screen when the power supply of the display module is turned on after the lock state is set at a time that the predetermined processing is not performed, wherein the lock state is canceled when a cancellation operation is performed in a state where the normal lock screen is displayed.

In the still further embodiment, the storing module (46) is a storage such as a RAM, and stores the normal lock screen. If the lock state is set when the predetermined processing is not performed, for example, since an arbitrary screen is not displayed, a lock screen is not produced. If the power supply of a display module is turned on in this state, the normal lock screen display processing module (30, S43) displays the normal lock screen.

According to the still further embodiment, if the lock state is set when the predetermined processing is not performed, the normal lock state screen can be displayed.

In a yet further embodiment, the producing module produces the lock screen that makes an arbitrary screen a background.

In the yet further embodiment, when the object for cancellation operation (RO, UO) is displayed on the lock screen, for example, the produced lock screen is displayed as a background of the object.

According to the yet further embodiment, since an arbitrary screen is displayed as the background of the lock screen, it becomes easy for the user to grasp a situation when the lock state is set.

In a yet still further embodiment, the arbitrary screen includes a home screen.

In the yet still further embodiment, if the lock state is set in a state where the home screen is displayed, the lock screen is produced based on the home screen.

In a further embodiment, the home screen includes a first icon for performing arbitrary processing, and the producing module produces a lock screen that includes the second icon corresponding to the first icon included in the home screen at a time that the lock state is set in a state where the home screen is displayed, and the canceling module cancels the lock state if a cancellation operation using the second icon when the lock state is set, and the portable terminal further comprising a performance module operable to perform the predetermined processing based on the first icon corresponding to the second icon if the cancellation operation using the second icon when the lock state is set.

In the further embodiment, a plurality of first icons (function icons) are included in the home screen, for example. The producing module produces the lock screen including the second icon corresponding to the first icon before shifting to the lock state, for example. The display processing module displays the produced lock screen on the display module if the power supply of the display module is turned on in the state where the lock state is set. The canceling module cancels the lock sate if the cancellation operation using the second icon is performed when the produced lock screen is displayed. The performance module (30, S89) performs the predetermined processing based on the second icon corresponding to the first icon if the cancellation operation using the second icon is performed when the produced lock screen is displayed.

According to the yet still further embodiment and the further embodiment, by displaying the lock screen produced based on the home screen, with feeling in operating the home screen, the user can the predetermined processing while canceling the lock state. Therefore, the operability for the user in the lock screen is improved.

In a still further embodiment, the producing module produces the lock screen based on an arbitrary screen when the lock state is set in a state where the arbitrary screen is displayed on the display module.

The other embodiment is a lock state control method in a portable terminal (10) that has a display module (14) and a touch panel (16) provided in the display module, and a lock state of restricting a performance of predetermined processing based on a touch operation can be set, a processor of the portable terminal performing steps of: producing (S5, S65) a lock screen based on an arbitrary screen; display-processing (S35, S83) the lock screen when a power supply of the display module is turned on in a state where the lock state is set; and canceling (S39, S87) the lock state when a cancellation operation is performed in a state where the lock screen is displayed.

According to also the other embodiment, the user can easily remember, before canceling the lock state, a situation before the lock state is set. Therefore, the operability for the user after the lock state is canceled is improved.

Although the present invention has been described and illustrated in detail, it is clearly understood that the same is by way of illustration and example only and is not to be taken by way of limitation, the spirit and scope of the present invention being limited only by the terms of the appended claims.

### DESCRIPTION OF NUMERALS

10—mobile phone

14—display

16—touch panel

30—processor

40—input device

44—flash memory

46—RAM

48—touch panel control circuit

1. A portable terminal that has a display module and a touch panel provided in the display module, and a lock state of restricting a performance of predetermined processing based on a touch operation can be set, comprising:
a producing module operable to produce a lock screen based on an arbitrary screen;
a display processing module operable to display the lock screen when a power supply of the display module is turned on in a state where the lock state is set; and
a canceling module operable to cancel the lock state when a cancellation operation is performed in a state where the lock screen is displayed.

2. The portable terminal according to claim 1, wherein the arbitrary screen is displayed when the predetermined processing is being performed, further comprising:
a storing processing module operable to store a performance situation of the processing being performed when the lock state is set; and
a resumption module operable to resume the predetermined processing based on the performance situation stored by the storing processing module when the cancellation operation is performed in a state where the lock screen is displayed.

3. The portable terminal according to claim 2, further comprising:
a storing module operable to store a normal lock screen; and
a normal lock screen display processing module operable to display the normal lock screen when the power supply of the display module is turned on after the lock state is set at a time that the predetermined processing is not performed,
wherein the lock state is canceled when a cancellation operation is performed in a state where the normal lock screen is displayed.

4. The portable terminal according to claim 1, wherein the producing module produces the lock screen that makes an arbitrary screen a background.

5. The portable terminal according to claim 1, wherein the arbitrary screen includes a home screen.

6. The portable terminal according to claim 5, wherein the home screen includes a first icon for performing arbitrary processing, and
the producing module produces a lock screen that includes the second icon corresponding to the first icon included in the home screen at a time that the lock state is set in a state where the home screen is displayed, and
the canceling module cancels the lock state if a cancellation operation using the second icon when the lock state is set, and the portable terminal, further comprising
a performance module operable to perform the predetermined processing based on the first icon corresponding to the second icon if the cancellation operation using the second icon when the lock state is set.

7. The portable terminal according to claim 1, wherein the producing module produces the lock screen based on an arbitrary screen when the lock state is set in a state where the arbitrary screen is displayed on the display module.

8. A lock state control method in a portable terminal that has a display module and a touch panel provided in the display module, and a lock state of restricting a performance of predetermined processing based on a touch operation can be set, a processor of the portable terminal performing steps of:
producing a lock screen based on an arbitrary screen;
display-processing the lock screen when a power supply of the display module is turned on in a state where the lock state is set; and
canceling the lock state when a cancellation operation is performed in a state where the lock screen is displayed.
